(19) United States
(12) Patent Application Publication
(10) Pub. No.: US 2024/0204355 A1
(43) Pub. Date: Jun. 20, 2024

(54) PROTECTIVE LAYER ON ANODE-FACING SURFACE OF SEPARATOR FOR MITIGATING POLYSUFIDE SHUTTLING IN LITHIUM-BASED BATTERIES

(71) Applicant: Lyten, Inc., San Jose, CA (US)

(72) Inventors: Parisa Bashiri, Fremont, CA (US); Celina Mikolajczak, San Carlos, CA (US); Babu Ganguli, Santa Clara, CA (US)

(21) Appl. No.: 18/083,405

(22) Filed: Dec. 16, 2022

(51) Int. Cl. H01M 50/449; H01M 10/0525; H01M 50/42; H01M 50/426; H01M 50/446

(52) U.S. Cl. CPC H01M 50/449; H01M 10/0525; H01M 50/42; H01M 50/426; H01M 50/446

(57) ABSTRACT

The presently described inventive concepts relate to unique configurations of lithium-sulfur batteries particularly adept for mitigating or even eliminating detrimental effects associated with polysulfide shuttling. Surprisingly, implementing a polymeric non-porous, ionically conductive, electrically non-conductive protective layer on the anode-facing surface of the separator yield unexpected improvements to battery performance including but not limited to substantially improved operational lifetime. Notably, these improvements are observed and significant even relative to configurations implementing an otherwise identical protective layer on the cathode-facing surface of the separator. The resulting batteries are characterized by light weight, high ionic conductivity, robust mechanical strength, and retaining high Columbic efficiency (e.g., at least 80% of peak) for over 250 charge cycles.

### FIELD OF THE INVENTION

The present invention relates to batteries, and more particularly to optimizing power density, energy density, and longevity in batteries.

### BACKGROUND

Lithium-based chemistry presents many promising opportunities for improving performance of modern energy storage technology. However, primary challenges to achieving such improvements include mitigating, or ideally preventing, detrimental impact caused, e.g., by formation of “dendritic” structures within the electrochemical cell, and the so-called “polysulfide shuttling” effect caused by parasitic reactions between the anode material and corresponding electrolyte. Both effects can cause increased impedance, reduced columbic efficiency, and ultimate failure of lithium-based batteries over time.

As such, there is thus a need for addressing these and/or other issues associated with the prior art.

### SUMMARY

According to one aspect of the presently disclosed inventive concepts, a lithium-sulfur battery includes an anode, a cathode, a separator positioned between the anode and the cathode, and a protective layer coating an anode-facing surface of the separator, wherein the protective layer is configured to mitigate polysulfide shuttling within the lithium-sulfur battery.

According to further aspects, the protective layer comprises a non-porous polymeric network. Moreover, the protective layer is preferably ionically conductive to at lithium ions and/or sodium ions. More preferably, the protective layer is electrically non-conductive. In various approaches, the protective layer is characterized by a thickness in a range from about 1 nm to about 20 microns. Most preferably, the protective layer is formed only on the anode-facing surface of the separator. Accordingly, a cathode-facing surface of the separator is preferably characterized by absence of any protective coating formed thereon. In addition, the cathode may be characterized by a loading of active material of at least about 5 mg/cm², and up to about 10 mg/cm², in various embodiments.

In various embodiments, the (polymeric) protective layer comprises a polymeric component and an ion-transporting component embedded in the polymeric component. The polymeric component may include one or more polymers characterized by a molecular weight in a range from about 100,000 g/mol to about 4,000,000 g/mol. Accordingly, in select implementations the polymeric component may include any combination or permutation of: poly(ethylene oxide) (PEO), polypropylene, polyvinylidene fluoride (PVDF), polyvinylidene fluoride-co-hexafluoropropylene (PVDF-HFP), polyacrylonitrile (PAN), and poly(methyl)methacrylate) (PMMA). Similarly, the ion-transporting component preferably includes one or more materials configured to facilitate lithium-ion transport, such as lithium bis(trifluoromethanesulfonyl)imide (LiTFSI), lithium perchlorate (LiClO⁴⁻), and/or lithium hexafluorophosphate (LiPF₆).

The relative amount of polymeric component and ion-transporting component may be tuned to achieve a desired balance between mechanical strength and ionic conductivity within the protective layer. For example, the polymeric component and the ion-transporting component may be present anywhere in a range from about a 20:1 molar ratio of the polymeric component to the ion-transporting component to about an 8:1 molar ratio of the polymeric component to the ion-transporting component.

Lithium-sulfur batteries as disclosed herein are advantageously characterized by an operational life cycle of over at least 250 cycles.

According to another aspect of the presently disclosed inventive concepts, a method includes forming a protective layer on one surface of a separator layer of a lithium-sulfur battery; and positioning the separator layer between an anode layer and a cathode layer of the lithium-sulfur battery, wherein the separator layer is arranged such that the protective layer faces the anode layer of the lithium-sulfur battery.

Additional features, aspects, and advantages of the inventive concepts presented herein will be described in further detail below with reference to the various Figures. It shall be understood that all features, aspects, components, configurations, etc. described herein and/or shown in the Figures are presented by way of example rather than limitation, Moreover, said features, aspects, components, configurations, etc. may be implemented in any suitable combination or permutation thereof that would be appreciated by a person having ordinary skill in the art upon reading the instant description, without departing from the scope of the inventive concepts set forth herein.

### BRIEF DESCRIPTION OF THE DRAWINGS

FIG. 1 illustrates a simplified schematic of an electrochemical cell, according to the prior art.

FIG. 2 is a simplified schematic of an electrochemical cell including a separator with an anode-facing protective layer, according to one aspect of the presently described inventive concepts.

FIG. 3 shows a simplified schematic of a mechanism for mitigating polysulfide shuttling using an electrochemical cell configuration as depicted in FIG. 2, according to one implementation of the presently described inventive concepts.

FIG. 4 is a scanning electron micrograph (SEM) image of a surface of a conventional separator lacking a protective coating layer, according to the prior art.

FIG. 5A is a scanning electron micrograph (SEM) image of a surface of a separator having a protective coating layer formed thereon, according to various aspects of the presently described inventive concepts.

FIG. 5B shows several photographic depictions of the surface of a lithium anode, an anode-facing surface of a separator having a protective layer formed thereon, and a cathode-facing surface of the same separator (lacking any protective coating formed thereon), according to several exemplary embodiments.

FIG. 5C shows several photographic depictions of the surface of a lithium anode, an anode-facing surface of a separator having no protective layer formed thereon, and a cathode-facing surface of the same separator which has a protective coating formed thereon, according to several exemplary embodiments. FIG. 5C also depicts “dead lithium” deposits formed on the uncoated, anode-facing surface of the separator, again according to several exemplary embodiments.

FIG. 6 depicts a graph illustrating relationship between impedance and resistance of an electrochemical cell including a separator having a protective layer formed on an anode-facing surface thereof, according to various embodiments.

FIG. 7A is a graph showing the relationship between cycle life (in terms of number of cycles) and charge retention of an electrochemical cell including a separator with no protective layer formed thereon, an electrochemical cell having a protective layer formed on a cathode-facing surface thereof, and an electrochemical cell having a protective layer formed on an anode-facing surface thereof, according to various embodiments.

FIG. 7B is a graph showing the relationship between cycle life (in terms of number of cycles) and Coulombic efficiency of an electrochemical cell having a protective layer formed on a cathode-facing surface thereof, and an electrochemical cell having a protective layer formed on an anode-facing surface thereof, according to various embodiments.

FIG. 8 illustrates a method for fabricating a lithium-sulfur battery having a protective layer formed on an anode-facing surface of a separator layer thereof, according to an illustrative implementation of the presently described inventive concepts.

### DETAILED DESCRIPTION

In conventional electrochemical cells, especially lithium-based electrochemical cells, and most especially lithium-sulfur-based electrochemical cells, a major source of reduced capacitance, excessive use of electrolyte, and corresponding limitations on functional lifetime of the cells, is polysulfide shuttling. Even in cell configurations employing a separator to isolate the anode and cathode (and corresponding electrolyte components), polysulfide shuttling remains a principal obstacle to further improvements to battery performance.

In addition, reversibility of the charge-discharge process is a significant limitation on operational cycle life, as degradation of the lithium anode over time reduces the capacitance achieved by the battery with each charge cycle.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

As understood herein, the term “operational life cycle”, “life cycle”, “cycle life” or any equivalent thereof used herein shall be appreciated as referring to a battery characterized by retaining at least about 80 percent capacitance (relative to peak capacitance achieved at or within about five cycles of initial charge) regardless of number of previous charge cycles. For example, a battery is considered within the “operational life cycle” so long as continuing charge cycles achieve a retained capacitance of about 80 percent or more of the peak capacitance achieved by the same battery initially, e.g., within about five cycles of initial charging. In alternative embodiments, charge cycle sufficient to remain “operational” may be determined otherwise, but only as expressly stated herein. Without any such disclaimer, it shall be understood that an operational life cycle of a battery is defined by the number of charge cycles over which the battery maintains at least about 80% charge retention relative to maximum charge, e.g., as achieved during the first few (˜5 or less) charge cycles. In further embodiments, operational lifetime may be defined in terms of different units of measure, such as maintaining about 80% of a maximum capacity or Columbic efficiency exhibited by a given battery throughout its entire span of operation (but again preferably a maximum capacity or Columbic efficiency, e.g., as determined within a first few (e.g., five or less) charge cycles of said battery).

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments-they are not representative of an exhaustive treatment of all possible embodiments, and they are not intended to impute any limitation as to the scope of the claims. In addition, an illustrated embodiment need not portray all aspects or advantages of usage in any particular environment.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor(s) for carrying out the claimed subject matter. Of course, variations of those embodiments will become apparent to those of ordinary skill in the art upon reading the foregoing description. The inventor(s)expects skilled artisans to employ such variations as appropriate, and the inventor(s)intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

Descriptions of Exemplary Embodiments with Comparison to the Prior Art

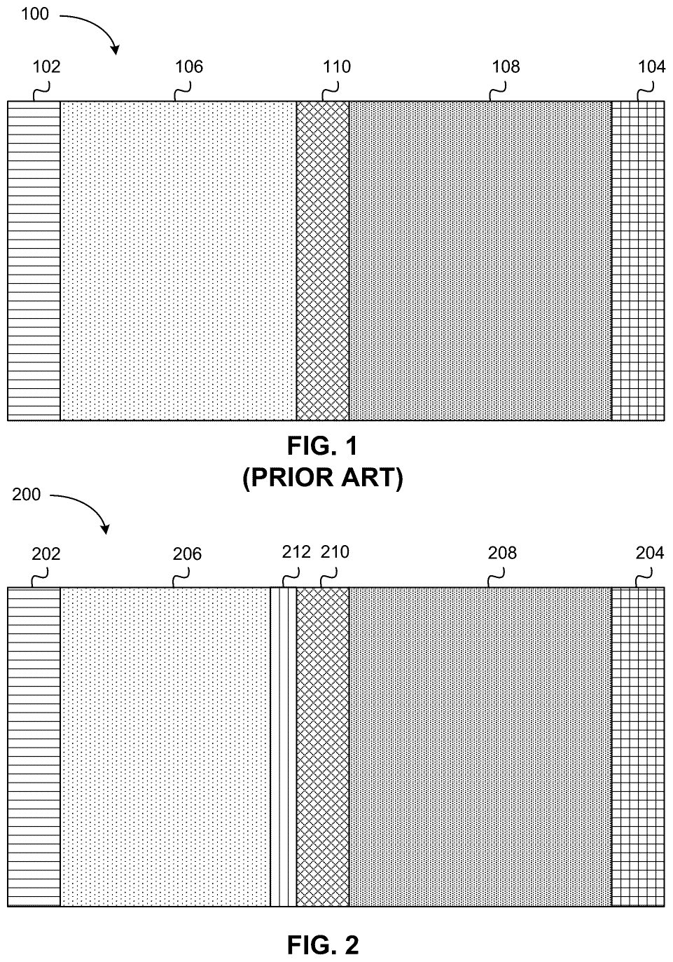

FIG. 1 illustrates a simplified schematic of an electrochemical cell 100, according to the prior art. The conventional electrochemical cell includes an anode 102, a cathode 104, and a separator 110 therebetween. Between, and in contact with the anode and the separator is a first electrolyte 106, while between, and in contact with the cathode is a second electrolyte 108. The anode 102, cathode 104, separator 110, first electrolyte material 106, and second electrolyte material may be formed from any material known in the art, and have any corresponding physical characteristics thereof, as would be appreciated by skilled artisans as of the priority date of the present application. Moreover, in various embodiments, first electrolyte 106 and second electrolyte 108 may be, or include, the same constituent materials, or different materials, without departing from the scope of the inventive concepts presented herein.

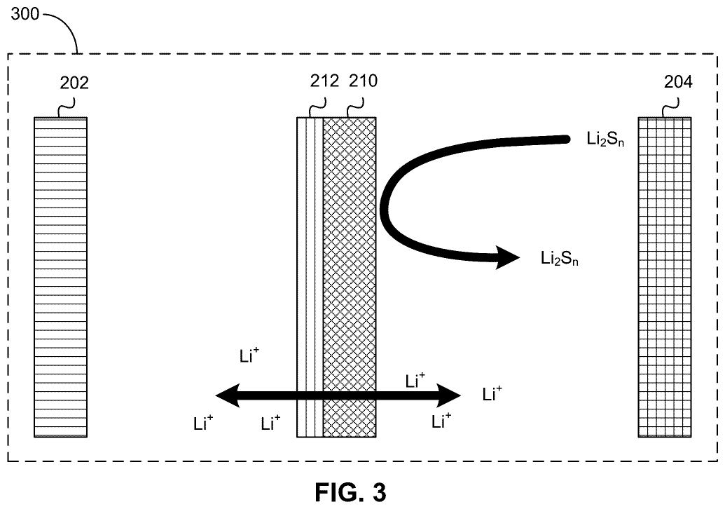

FIG. 2 is a simplified schematic of an inventive electrochemical cell 200 including a separator 210 with an anode-facing protective layer 212 formed thereon, according to one aspect of the presently described inventive concepts. As with the configuration shown in FIG. 1, the electrochemical cell 200 shown in FIG. 2 includes an anode 202, a cathode 204, a separator 210, a first electrolyte 206, and a second electrolyte 208. However, unlike the conventional configuration shown in FIG. 1, electrochemical cell 200 according to the inventive concepts presented herein includes a protective layer 212 formed on an anode-facing surface of the separator 210.

In other words, the separator 210 of the presently described invention is characterized by having a protective layer 212 formed on the anode-facing surface thereof, and an absence of any such protective layer (or corresponding material) on the cathode-facing surface thereof.

As understood herein, “absence” of a protective coating layer refers to configurations excluding a protective layer of similar composition or function as described herein regarding protective layer 212 formed on the anode-facing surface of the separator (e.g., a protective layer separately formed on the cathode-facing surface of the separator component), as well as configurations in which part of the protective layer formed on the anode-facing surface of the separator penetrate the pores thereof, forming a partial or complete layer of the same material, or particular components thereof, on the cathode-facing surface of the separator, according to various embodiments.

In preferred approaches, the “lack” or “absence” of protective layer “on the cathode-facing surface of the separator” refers to configurations in which the cathode-facing surface of the separator lacks any non-the cathode-side facing layer of the separator. For instance, in one approach, absence of a protective layer on the cathode-facing surface of the separator may refer to a situation in which the cathode-facing surface of the separator does not include, is not bonded to, nor in any other way incorporates (by composition, structure, or function) any of the compound(s) included in the protective layer formed on the anode-facing surface of the separator.

Preferably, the protective layer 212 covers an entire anode-facing surface of the separator 210, forming an effective mechanism for blocking passage of at least lithium polysulfides from the cathode 204 through the separator 210 and toward the anode 202. For instance, in one approach, the protective layer 212 comprises a polymeric network covering an entire anode-facing surface of the separator 210. More preferably, the polymeric network is non-porous, e.g., in the form of a network or matrix of interlocking polymer chains (“fibers”) ideally having negligible permissivity, permeability, etc. to lithium polysulfides. Still more preferably, the protective layer 212 is (ionically) conductive to lithium ions (Lit as shown in FIG. 2), but not electrically conductive. Accordingly, lithium ions may be transported across the protective layer/separator and recombine with sulfides on the cathode-facing surface of the electrochemical cell (e.g., in the region occupied by second electrolyte 108 as shown in FIG. 1) to form lithium polysulfides that, as described above, are retained on the cathode-facing surface of the electrochemical cell via the separator 210 and/or protective layer 212.

According to various implementations, the protective layer 212 may comprise, consist essentially, or consist entirely of one or more polymers present as a non-porous matrix covering the anode-facing surface of the separator 210, e.g., as a thin layer formed to a thickness in anywhere in a range from about 1 nm to about 20 μm, e.g., a thickness in a range from about 1 nm to about 20 μm, a thickness in a range from about 1 nm to about 10 μm, a thickness in a range from about 1 nm to about 5 μm, a thickness in a range from about 1 nm to about 1 μm, a thickness in a range from about 1 nm to about 500 nm, a thickness in a range from about 1 nm to about 200 nm, a thickness in a range from about 1 nm to about 100 nm, a thickness in a range from about 1 nm to about 50 nm, a thickness in a range from about 1 nm to about 10 nm, a thickness in a range from about 1 nm to about 5 nm, a thickness in a range from about 5 nm to about 10 nm, a thickness in a range from about 10 nm to about 100 nm, a thickness in a range from about 100 nm to about 200 nm, a thickness in a range from about 200 nm to about 500 nm, a thickness in a range from about 500 nm to about 1 μm, a thickness in a range from about 1 μm to about 5 μm, a thickness in a range from about 1 μm to about 10 μm, a thickness in a range from about 5 μm to about 10 μm, a thickness in a range from about 10 μm to about 20 μm, etc. as would be understood by a person having ordinary skill in the art upon reading the present disclosure. Of course, any subrange within the overall range of about 1 nm to about 20 μm may be employed, including endpoints (singular, or in combination) other than those expressly set forth above, without departing from the scope of the inventive concepts presented herein. In particularly preferred embodiments, the protective layer thickness is about several (e.g. 1-7) μm. Skilled artisans will appreciate that increasing thickness of the protective layer lends additional mechanical strength both to the layer itself, and to the anode on which it is formed, but can cause decreasing ionic conductivity. Accordingly, preferred embodiments of the protective layer are characterized by a thickness that appropriately balances mechanical strength and ionic conductivity, which again the inventors have found to be about several microns (e.g., preferably about 1-7 microns, more preferably about 3-5 microns, or most preferably about 5 microns.

With respect to the polymer component of the protective layer 212, while any suitable polymer(s) capable of forming a non-porous, electrically non-conductive, and ionically conductive matrix may be employed without departing from the scope of the presently described inventive concepts. However, in particularly preferred approaches (as described in greater detail below with respect to surprising results observed experimentally in connection with certain embodiments of the inventive concepts presented herein), the polymer component of the protective layer comprises poly(ethylene oxide) (PEO), polypropylene, polyvinylidene fluoride (PVDF), polyvinylidene fluoride-co-hexafluoropropylene (PVDF-HFP), polyacrylonitrile (PAN), poly(methyl)methacrylate) (PMMA), combinations thereof, or any suitable equivalent or alternative(s) that would be appreciated by a person having ordinary skill in the art upon reading the present disclosure. Again, preferably the resulting matrix is non-porous, electrically nonconductive, and ionically conductive (at least with respect to lithium ions).

The polymer(s) or polymeric components forming the protective matrix of the protective layer 212 may be characterized by a molecular weight in a range from about 100,000 g/mol to about 4,000,000 g/mol, in a range from about 100,000 g/mol to about 1,000,000 g/mol, in a range from about 100,000 g/mol to about 600,000 g/mol, or in a range from about 100,000 g/mol to about 200,000 g/mol, according to various embodiments, In further embodiments, the polymeric components forming the protective matrix of the protective layer 212 may be characterized by a molecular weight in a range from about 200,000 g/mol to about to about 4,000,000 g/mol, in a range from about 600,000 g/mol to about 4,000,000 g/mol, or in a range from about 1,000,000 g/mol to about 4,000,000 g/mol. Of course, the various endpoints of the nested ranges set forth above are provided by way of example only, and it shall be understood that the polymer network of the protective layer 212 may be characterized by component(s) having a molecular weight anywhere in the range from about 100,000 g/mol to about 4,000,000 g/mol, according to various embodiments and without departing from the scope of the inventive concepts presented herein.

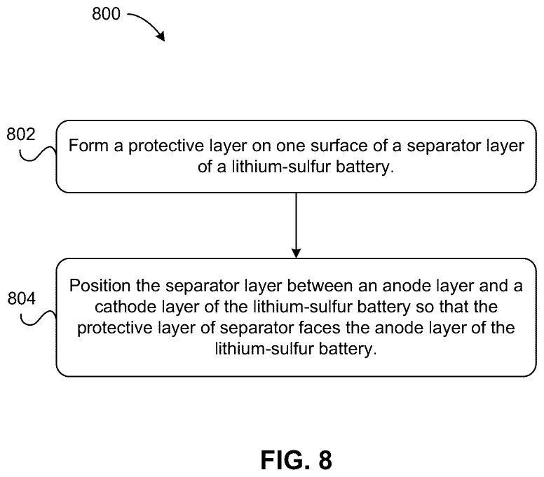

As will be described in greater detail with respect to FIG. 8 and exemplary methods of fabricating inventive lithium-sulfur batteries having a separator with an anode-facing protective layer, the polymer network may be formed using various solvents, such as acetonitrile, water, ethanol, N-methyl-2-pyrrolidone, or any suitable combination, alternative, or equivalent thereof that would be appreciated by a person having ordinary skill in the art upon reading the present disclosure.

Preferably, the protective layer also comprises one or more compounds that provide or facilitate lithium-ion transport through a polymer matrix, for example one or more salts such as lithium-bis(trifluoromethanesulfonyl)imide (LiTSFI), lithium hexafluorophosphate (LiPF₆), lithium perchlorate (LiClO₄), combinations thereof, or any suitable equivalent or alternative compounds for facilitating lithium-ion transport through the polymeric matrix.

The inventors have tested several exemplary compositions according to the foregoing general guidance, and found that the (molar) ratio of polymer to salt (or other compound conveying ion transport functionality) may play an important role in balancing the mechanical strength and electrical properties (particularly Li ion transport) of the resulting protective layer. Accordingly, in various implementations, the ratio or polymer to salt (again, molar) ratio may be in a range from about anywhere from about 20 mol polymer to about 1 mol salt (or other ion transport facilitating compound(s)). Of course, in various embodiments, suitable polymer to salt ratios may be in any range within the aforementioned broad amounts, e.g., in a (polymer: salt molar) range from about 15:1, about 20:1, about 16:1, about 12:1, about 8:1, or any range within the overall boundaries of about 20:1 molar ratio of polymer to salt (again, or other ion-transport facilitating material as would be understood by a person having ordinary skill in the art upon reading the present disclosure), without limitation. The aforementioned ranges of polymer to salt (or other ion-transport facilitating material) notwithstanding, the inventors have experimentally determined that a ratio of approximately 15 mol polymer component to about 1 mol ion-transporting component (salt).

Of course, as will be appreciated by persons having ordinary skill in the art upon reading the present descriptions, the protective layer may optionally include, or be formed from, a number of different components to tune characteristics of the polymer layer, such as binders, cross-linkers, dispersants, initiators, terminators, etc. in any combination or permutation without departing from the scope of the inventive concepts presented herein.

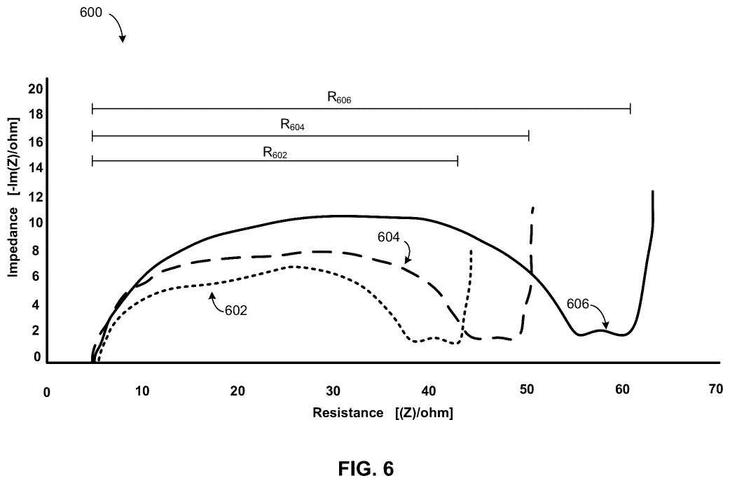

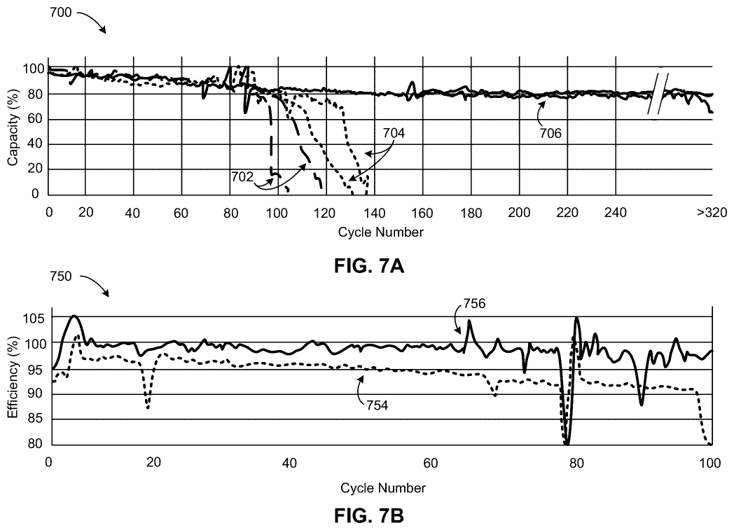

As a result of the foregoing characteristics, the presently disclosed inventive batteries exhibit an advantageously long operational lifetime, despite high loading of active material with respect to the cathode. For instance, according to several exemplary aspects, lithium batteries disclosed herein may be characterized by a cathode active material loading in a range from about 5 mg/cm² to about 10 mg/cm², an active material loading in a range from about 7 mg/cm² to about 9 mg/cm², or an active material loading in a range from about 7.5 mg/cm² to about 8 mg/cm². Despite such high loading of active material, which typically corresponds to greater polysulfide shuttling and corresponding detriments, the inventive implementations described herein exhibit improved charge retention (see, e.g., FIG. 6 and corresponding descriptions below), substantially extended and stable operational lifetime (e.g., over 250 cycles or more as shown in FIG. 7A, discussed in greater detail below) and improved Coulombic efficiency (see FIG. 7B and corresponding descriptions below).

These improvements are particularly apparent upon comparison to performance characteristics of otherwise identical battery configurations having a protective layer formed only on the cathode-facing surface of the separator, or no protective layer on either surface of the separator. Accordingly, the observed improvements may be attributed to the particular composition and/or configuration of the protective layer, i.e., being formed on the anode-facing surface of the separator, and comprising material(s) described herein, as well as any suitable equivalent thereof that would be appreciated by a person having ordinary skill in the art upon reading this disclosure.

Surprisingly, as will be described in further detail hereinbelow according to experimental observations summarized in FIG. 7A, the presently disclosed inventive approach of implementing a protective layer on an anode-facing surface of the separator yields substantially improved battery performance, particularly with respect to retained capacitance over number of cycles, relative to otherwise identical battery configurations having no protective layer on the separator, and battery configurations having an identical protective layer formed on the cathode side of the separator, but not the anode side of the separator.

As known in the art, one important function of the separator in lithium sulfur batteries is to block lithium polysulfide(s) (Li₂Sₙ, where 4≤n≤8), which are exclusively formed on the surface of the cathode during the discharge process from shuttling active material away from the cathode toward the anode and causing corresponding loss of performance. Lithium polysulfides, if not contained, dissolve into the electrolyte, and pass-through porous separator materials to ultimately form deposits on the anode. These deposits are formed via irreversible chemical reactions between the lithium content of the anode, and cause loss of active material (and corresponding performance detriments) within the battery. Accordingly, reversibility of the chemical reactions are also an important characteristic for improved performance of lithium-based batteries.

The improvements in performance observed in association with the presently described inventive concepts are surprising, in part, because typically placing or forming a protective layer on the anode-side of the separator is expected to have negligible, if any, impact on polysulfide shuttling between the cathode and the cathode-side of the separator. Put simply, since such a protective layer is not physically, electrically, chemically, or otherwise serving to separate the cathode and the separator, no appreciable barrier exists to mitigate the formation of polysulfides at the cathode-electrolyte interface. Conventional wisdom holds that such a protective layer would detriment battery performance, since while active material removed from the cathode (in the form of polysulfides) may still migrate into pores of the separator and lose contact with the cathode.

Moreover, coating the anode side of the separator can cause undesirable side reactions and formation of a passivation layer on the lithium metal of the anode. This tends to increase cell impedance, and ultimately may result in cell failure (e.g., unacceptable charge retention).

Accordingly, as demonstrated by Chiu, et al. (“A Poly)ethylene oxide)/Lithium bis(trifluoromethanesulfonyl)imide-Coated Polypropylene Membrane for a High-Loading Lithium Sulfur Battery), if a protective layer is to be included with or on a separator of a lithium-sulfur battery, the protective layer is conventionally formed on the cathode side of the separator. Such protective layers function by holding polysulfides at the cathode material host, preventing active material loss.

Without wishing to be bound to any particular theory, the inventor(s) of the presently described inventive concepts have observed that certain materials may be employed as a protective layer apparently without incurring the foregoing expected detriments, possibly via structurally supporting lithium metal and/or lithium-containing compounds (such as lithium polysulfides) that translates to improved cyclability of lithium metal, and corresponding increased operational lifetime. Moreover, the protective layer was observed to play two additionally important roles when formed on the anode-facing surface of the separator. First, presence of the protective layer improves uniformity of Li ion plating and stripping, which yields a better quality Li metal anode. Second, while so-called “dead” lithium tends to attach to uncoated separator and disconnect from the anode (resulting in loss of anode active material), in the presence of a protective layer formed on the anode-facing surface of the separator, dead lithium may still form, but does not detach from (i.e., retains electrical coupling with) the anode, allowing this “dead” lithium to continue participating in charge-discharge processes, and maintaining reversibility thereof.

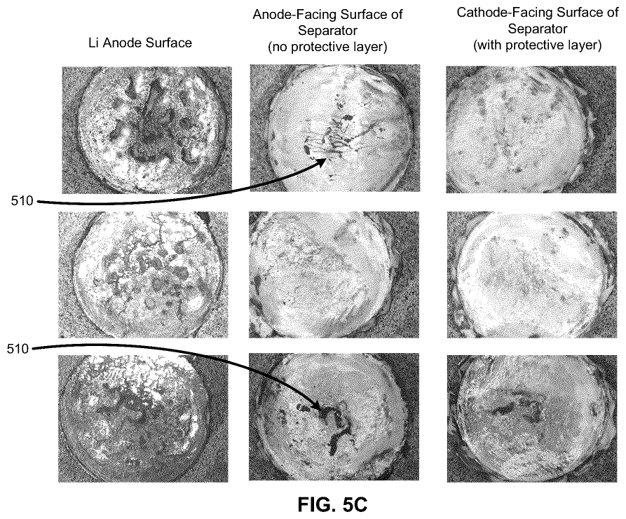

The uniformity of the anode surface, as well as both coated and uncoated surfaces of the separator, are shown in the images of FIGS. 5B-5C according to several exemplary embodiments of the presently described inventive concepts. Similarly, formation of dead lithium is depicted in the images of FIG. 5C. Additional details regarding these Figures and corresponding features is set forth hereinbelow.

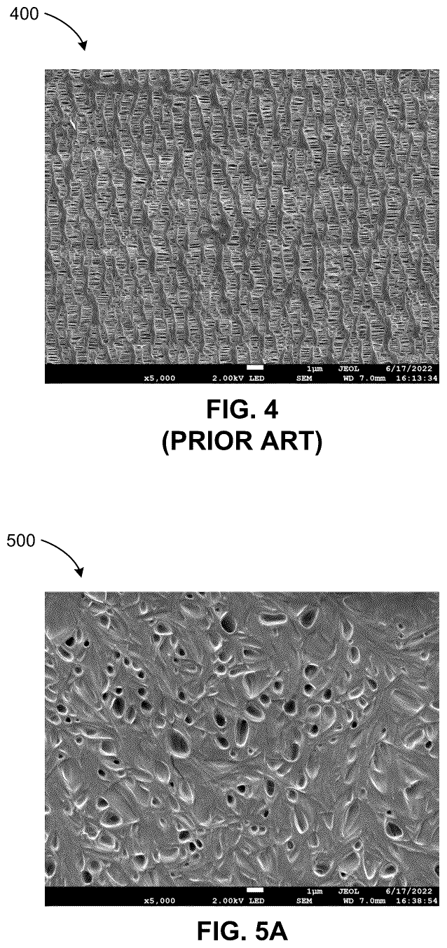

FIG. 3 shows a simplified schematic 300 of a mechanism for mitigating polysulfide shuttling using an electrochemical cell configuration as depicted in FIG. 2, according to one implementation of the presently described inventive concepts. Importantly, the preferred lithium-sulfide battery compositions and configurations of the inventive concepts described herein increase cathode particle/electrolyte wettability, which in turn facilitates lithium-ion transport while mitigating or preventing polysulfide shuttling effects that otherwise occur in conventional charge/discharge processes of lithium-sulfur batteries in operation.

For instance, as described herein in greater detail with respect to FIGS. 2, 7, and 8, parasitic and other reactions at or within the cathode 204 may result in generation of lithium sulfide compounds (e.g., Li₂Sₙ, where n may be 2, 4, 6, or 8) according to various mechanisms well known in the art. As an example, during discharge, lithium polysulfides ((Li₂Sₙ, where 4≤n≤8) are in liquid phase and may leave the cathode 204 by being dissolved in liquid electrolyte, and cross the separator 210 toward the anode 202. These liquid polysulfides may be further reduced to solid polysulfide at the anode surface and form permanent deposits thereon. Notably, this reaction is fully reversible during the charge process, but only if polysulfides have not been reduced into solid deposits formed on the anode surface(s).

Conventional approaches typically attempt to mitigate “shuttling” of polysulfides via applying a protective coating to the cathode itself, or to the cathode side of the separator. However, these approaches often fail to adequately address detrimental performance and ultimate failure of the overall electrochemical cell.

The presently described inventive concepts surprisingly and unexpectedly achieve superior performance characteristics (particularly regarding operational life style) by forming a protective layer 212 on the anode side of the separator 210, ideally without any corresponding protective layer or other protective mechanism on the cathode side of the separator 210, on the cathode 204 itself, or anywhere else in the electrical path between the anode side of the separator 210 an the cathode 204 itself.

Moreover, since the protective layer 212 formed on the anode side of the separator 210 is ionically conductive, e.g., preferably configured chemically to facilitate transport of lithium ions, sodium ions, etc. as would be appreciated by a person having ordinary skill in the art upon reading the instant descriptions, the lithium ions Lit may transport from the anode side of the separator 210 toward the cathode 204, and from the cathode side of the separator 210 toward the anode 202, further mitigating formation of dendrites or other undesirable electrochemical structures and/or compositions that would inhibit or defeat performance of an electrochemical cell otherwise as shown, e.g., in FIGS. 2-3, and corresponding descriptions presented elsewhere herein.

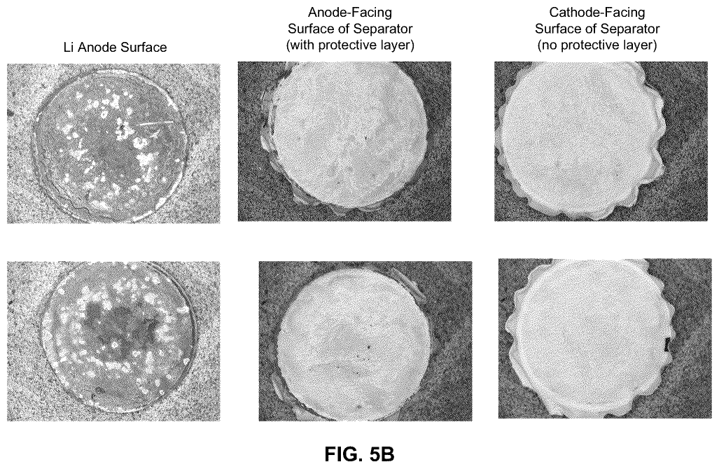

FIG. 4 is a scanning electron micrograph (SEM) image 400 of a surface of a conventional separator lacking a protective coating layer, according to the prior art. As will be appreciated by those having ordinary skill in the art upon viewing FIG. 4, the conventional separator (without any coating) is typically a porous structure to facilitate ion transport from the cathode side of the separator toward the anode side of the separator (and/or the opposite), in myriad approaches).

FIG. 5A is a scanning electron micrograph (SEM) image 500 of a surface of a separator having a protective coating layer formed thereon, according to various aspects of the presently described inventive concepts. By contrast to the conventional, non-coated separator as shown in FIG. 4, the protective layer shown in FIG. 5 coats one or more, preferably all or substantially all, of the surface(s) of the separator on a side facing the anode of the electrochemical cell. As detailed hereinabove regarding FIG. 2 and protective layer 212, the polymeric network of the protective layer 212 is non-porous, electrically non-conductive, and ionically conductive, in order to selectively facilitate transport of lithium ions while mitigating, or more desirably eliminating, detrimental effects of polysulfides preset in the electrochemical cell environment.

FIG. 5B shows several photographic depictions of the surface of a lithium anode, an anode-facing surface of a separator having a protective layer formed thereon, and a cathode-facing surface of the same separator (lacking any protective coating formed thereon), according to several exemplary embodiments. Notably, the surface of the lithium anode, as well as both the anode-facing and cathode-facing surfaces of the separator are characteristically uniform. In particular, the protective layer formed on the anode-facing surface of the separator is characterized by a substantially uniform thickness (preferably in a range of several microns, more preferably about 5 microns).

FIG. 5C shows several photographic depictions of the surface of a lithium anode, an anode-facing surface of a separator having no protective layer formed thereon, and a cathode-facing surface of the same separator which has a protective coating formed thereon, according to several exemplary embodiments. By comparison to the examples shown in FIG. 5B, it is apparent that the surface of the lithium anodes in embodiments having a protective coating formed on the cathode-facing surface of the separator, but not on the anode-facing surface, lack the substantial uniformity characteristic of the exemplary anode surfaces in embodiments having an anode-facing surface of the separator coated with a protective layer.

FIG. 5C also depicts “dead lithium” deposits formed on the uncoated, anode-facing surface of the separator, again according to several exemplary embodiments. The most prominent example of such dead lithium deposits 510 is seen in the top-center and bottom-center images of FIG. 5C. As will be appreciated by those having ordinary skill in the art, while dead lithium deposits can become inactive upon detachment from the anode (i.e., loss of electrical coupling between the anode and the separator via the dead lithium deposit), so long as a (preferably physical) connection or electrical coupling remains between the anode and the separator surface via the dead lithium deposit, the dead lithium remains conductive and may continue participation in charge-discharge processes, extending the operational lifetime of the battery.

The comparative examples shown in FIGS. 5B and 5C accordingly demonstrate that embodiments having a protective coating formed on an anode-facing surface of the separator, and not having any such protective layer formed on the cathode-facing surface of the separator, exhibit improved anode durability, particularly in long cycling applications. These examples confirm and further characterize the surprising and unexpected advantages of forming a protective layer on the anode-facing surface of the separator but not on the cathode-facing surface of the separator, which as described hereinabove is contrary to the expectation that such embodiments would not prevent polysulfide shuttling as effectively as an otherwise identical configuration having a protective layer formed on the cathode-facing surface of the separator, but no such protective layer formed on the anode-facing surface of the separator.

FIG. 6 depicts a graph 600 illustrating relationship between impedance and resistance of an electrochemical cell including a separator having a protective layer formed on an anode-facing surface thereof (curve 602), an electrochemical cell including a separator having a protective layer formed on a cathode-facing surface thereof (curve 604), and an electrochemical cell having a separator without any protective layer formed on either the cathode-facing surface or the anode-facing surface thereof (curve 606), according to various embodiments.

As can be seen from FIG. 6, inclusion of a protective layer on the cathode-facing surface of the separator yields decreased resistance R₆₀₄ relative to embodiments lacking any protective layer on either surface of the separator (as indicated by R₆₀₆). Furthermore, including a protective layer on the anode-facing surface of the separator yields even further decreased resistance R₆₀₂ relative to resistance R₆₀₄ of embodiments having a protective layer on the cathode-facing surface of the separator. The inventors posit this difference is due to improved wettability of cathode particles in the presence of a protective layer, particularly on the anode-facing surface of the separator.

FIG. 7A is a graph 700 showing the relationship between electrochemical cell lifetime (in terms of number of cycles and charge retention) of an electrochemical cell including a separator with no protective layer formed thereon (dashed lines 702), an electrochemical cell having a protective layer formed on a cathode-facing surface thereof (dotted lines 704), and an electrochemical cell having a protective layer formed on an anode-facing surface thereof (solid lines 706), according to various embodiments. As evident from the trend demonstrated in FIG. 7A, the embodiments including an electrochemical cell with a protective layer on the anode side of the separator (but not on the cathode side) exhibit substantially stable capacity over at least 250 cycles according to one embodiment, and over 300 cycles in accordance with preferred embodiments. Meanwhile, the embodiments having otherwise identical protective layers formed solely on the cathode side of the separator exhibit improved operational lifecycle, relative to separator without any protective coating, these cells exhibit substantial loss of capacity at or around 115-120 charge cycles. Finally, as a baseline, otherwise identical electrochemical cells without any protective layer whatsoever formed on the separator exhibit stable capacity over about 80-100 cycles.

FIG. 7B is a graph 750 showing the relationship between electrochemical cell lifetime (in terms of number of cycles and Coulombic efficiency) of an electrochemical cell having a protective layer formed on a cathode-facing surface thereof (dotted line 754), and an electrochemical cell having a protective layer formed on an anode-facing surface thereof (solid line 756), according to various embodiments. Skilled artisans will appreciate that dotted line 754 and solid line 756 respectively represent average performance of the respective embodiments as observed over a multitude of identical samples tested under identical conditions.

As evident from the trend demonstrated in FIG. 7B, the embodiments including an electrochemical cell with a protective layer on the anode side of the separator (but not on the cathode-facing surface) exhibit substantially stable, and greater Coulombic efficiency (e.g., in a range from about 95-100%) over at least 100 cycles. Meanwhile, the embodiments having otherwise identical protective layers formed solely on the cathode-facing surface of the separator exhibit Coulombic efficiency in a range from about 90-95% over approximately 100 charge cycles.

Accordingly, and again to the surprise of the inventors for reasons discussed hereinabove regarding FIGS. 2 and 3, lithium-sulfur batteries including an electrochemical cell configuration wherein the separator is coated with a protective layer on the anode-facing surface only (i.e., without any such protective coating on the cathode side of the separator) are the most preferred configuration for retaining capacity over a large number of charge cycles. Since ionic conductivity efficiency tends to come at the cost of mechanical strength, a further advantage of the inventive concepts presented herein is that use of a catalyst embedded in the protective layer, such as a salt or combination of salts configured to facilitate lithium-ion transfer. Accordingly, the presently disclosed inventive embodiments improve both the electrochemical characteristics of the resulting cell, as well as improving mechanical strength to cooperatively improve operational lifetime of the resulting batteries.

FIG. 8 illustrates a method 800 for forming a lithium-sulfur battery having a protective coating on an anode side of the separator thereof for mitigating polysulfide shuttling within the lithium-sulfur battery. The method 800 may be performed using any suitable apparatus, or in any suitable environment, that would be appreciated by a person having ordinary skill in the art upon reading the present descriptions. Moreover, the method 800 may be used to fabricate any embodiment of the presently described inventive concepts, including but not limited to those shown in FIGS. 2-3 and exhibiting characteristics as described herein with respect to FIGS. 5A-7, or any combination thereof, without departing from the scope of the invention disclosed herein.

As shown in FIG. 8, method 800 includes operation 802, in which a protective layer is formed on one surface of a separator layer (e.g., on a material suitable for use as a separator in a lithium-sulfur or other similar battery). The protective layer may be formed, in various embodiments, using any suitable technique that would be appreciated by persons having ordinary skill in the art, upon reading the instant disclosure. For instance, in several exemplary approaches, the protective layer may be formed using techniques such as a tape casting method, a reel-to-reel (R2R) method, a “dr. blade” method (which, as will be appreciated by skilled artisans, involves positioning a sharp blade at a fixed height above a (optionally planar) substrate, pouring a slurry (e.g. of protective layer precursor materials such as polymers, polymeric precursors, binders, crosslinkers, solvents, dispersants, ionically conductive salts, etc.) over the substrate, and running the blade over the slurry-coated substrate surface to form a layer of material thereon) an electrospinning approach, etc. as would be understood by skilled artisans upon reading the present disclosure. Preferably, the formation technique allows precise control over the coating thickness, drying temperature, and/or atmospheric conditions during fabrication of the protective layer. For instance, it is preferable to avoid conditions that would result in chemical reactions between the separator material and compounds other than those (or precursors) of the protective layer being formed thereon.

With continuing reference to FIG. 8, method 800 includes operation 804, wherein the separator layer (having the protective layer formed on one surface thereof per operation 802) is positioned between an anode layer and a cathode layer of the lithium-sulfur battery, such that the protective layer faces the anode layer of the lithium-sulfur battery. The positioning of the separator layer relative to the anode and cathode layers, along with electrolyte materials (e.g., a first and second electrolyte material as described hereinabove with respect to FIG. 2) forms a non-porous barrier preventing electrical conductivity between the cathode layer and the anode layer, but facilitating ion transport through the protective layer (and corresponding separator material), especially to ions such as lithium, potassium, and sodium, and any equivalent or alternative thereof that would be appreciated by a person having ordinary skill in the art upon reviewing the subject matter set forth herein.

Of course, the method 800 described herein may include any number of additional and/or alternative operations, features, etc. besides those set forth above and shown in FIG. 8, including any feature described hereinabove with respect to the components shown in FIGS. 2-3, and 5A-7, without departing from the scope of the inventive concepts disclosed herein.

For instance, in various implementations of method 800, the composition of the protective layer may be or include any compound(s) listed hereinabove with respect to protective layer 212 as shown in FIGS. 2-3. Similarly, the protective layer may have any suitable thickness, positioning, configuration, functionality, etc. as described herein regarding FIGS. 2-3 and/or 5A-7.

The inventive concepts presented herein have been described with respect to particular exemplary embodiments and illustrative implementations to demonstrate the various aspects and advantages thereof. However, it will be appreciated that the foregoing descriptions are indeed provided by way of example rather than limitation, and the embodiments set forth herein are not to be taken as limiting on the scope of the invention in any manner.

Moreover, the various aspects presented herein, and corresponding characteristics, may be combined in any suitable manner, permutation, or combination, unless otherwise expressly stated herein, without departing from the scope of the inventive concepts in this disclosure. Similarly, unless expressly stated otherwise, any suitable equivalent or alternative of the exemplary components, features, functionalities, etc. that would be appreciated by a person having ordinary skill in the art may be utilized in the context of the present disclosure without departing from the scope of the inventive concepts set forth herein.

What is claimed is:

1. A lithium-sulfur battery, comprising:
an anode;
a cathode;
a separator positioned between the anode and the cathode; and
a protective layer coating an anode-facing surface of the separator, wherein the protective layer is configured to mitigate polysulfide shuttling within the lithium-sulfur battery.

2. The lithium-sulfur battery as recited in claim 1, wherein the protective layer comprises a non-porous polymeric network.

3. The lithium-sulfur battery as recited in claim 1, wherein the protective layer is ionically conductive to lithium ions.

4. The lithium-sulfur battery as recited in claim 1, wherein the protective layer is electrically non-conductive.

5. The lithium-sulfur battery as recited in claim 1, wherein the protective layer is non-porous.

6. The lithium-sulfur battery as recited in claim 1, wherein the protective layer is formed to a thickness in a range from about 1 nm to about 20 microns.

7. The lithium-sulfur battery as recited in claim 1, wherein the protective layer comprises a polymeric component and an ion-transporting component embedded in the polymeric component.

8. The lithium-sulfur battery as recited in claim 7, wherein the polymeric component comprises: poly(ethylene oxide) (PEO), polypropylene, polyvinylidene fluoride (PVDF), polyvinylidene fluoride-co-hexafluoropropylene (PVDF-HFP), polyacrylonitrile (PAN), poly(methyl)methacrylate) (PMMA), or any combination thereof.

9. The lithium-sulfur battery as recited in claim 7, wherein the ion-transporting component comprises one or more materials configured to facilitate lithium-ion transport.

10. The lithium-sulfur battery as recited in claim 9, wherein the ion-transporting component is selected from the group consisting of lithium bis(trifluoromethanesulfonyl)imide (LiTFSI)m lithium perchlorate (LiClO⁴⁻), and lithium hexafluorophosphate (LiPF₆).

11. The lithium-sulfur battery as recited in claim 7, wherein the polymeric component and the ion-transporting component are present in a range from about a 20:1 molar ratio of the polymeric component to the ion-transporting component to about an 8:1 molar ratio of the polymeric component to the ion-transporting component.

12. The lithium-sulfur battery as recited in claim 7, wherein the polymeric component comprises one or more polymers characterized by a molecular weight in a range from about 100,000 g/mol to about 4,000,000 g/mol.

13. The lithium-sulfur battery as recited in claim 1, wherein the protective layer is formed only on the anode-facing surface of the separator.

14. The lithium-sulfur battery as recited in claim 1, wherein a cathode-facing surface of the separator is characterized by absence of any protective coating formed thereon which is configured to mitigate lithium polysulfide shuttling within the lithium-sulfur battery.

15. The lithium-sulfur battery as recited in claim 1, wherein a cathode-facing surface of the separator is characterized by absence of any protective coating formed thereon which is configured to mitigate lithium polysulfide shuttling within the lithium-sulfur battery.

16. The lithium-sulfur battery as recited in claim 1, wherein the lithium-sulfur battery is characterized by an operational life cycle of over at least 250 cycles.

17. The lithium-sulfur battery as recited in claim 1, wherein the cathode is characterized by a loading of active material of at least about 5 mg/cm² or more.

18. A method, comprising
forming a protective layer on one surface of a separator layer of a lithium-sulfur battery; and
positioning the separator layer between an anode layer and a cathode layer of the lithium-sulfur battery, wherein the separator layer is arranged such that the protective layer faces the anode layer of the lithium-sulfur battery.

19. The method as recited in claim 18, wherein the protective layer comprises a polymeric component and an ion-transporting component embedded in the polymeric component; and
wherein the polymeric component comprises: poly(ethylene oxide) (PEO), polypropylene, polyvinylidene fluoride (PVDF), polyvinylidene fluoride-co-hexafluoropropylene (PVDF-HFP), polyacrylonitrile (PAN), poly(methyl)methacrylate) (PMMA), or any combination thereof.

20. The method as recited in claim 18, wherein the protective layer comprises a polymeric component and an ion-transporting component embedded in the polymeric component; and
wherein the ion-transporting component is selected from the group consisting of lithium bis(trifluoromethanesulfonyl)imide (LiTFSI)m lithium perchlorate (LiClO⁴⁻), and lithium hexafluorophosphate (LiPF₆).
